(19) United States
(12) Patent Application Publication
(10) Pub. No.: US 2006/0071880 A1
(43) Pub. Date: Apr. 6, 2006

(54) Device for generating sustain signals on the columns of a plasma panel, and plasma panel comprising this device

(76) Inventors: Dominique Gagnot, Charavines (FR); Hassane Guermoud, Rennes (FR); Philippe Le Roy, Betton (FR)

Correspondence Address: THOMSON LICENSING INC., PATENT OPERATIONS, PO BOX 5312, PRINCETON, NJ, 08543-5312, US

(21) Appl. No.: 11/235,359

(22) Filed: Sep. 26, 2005

(30) Foreign Application Priority Data
Oct. 1, 2004 (FR) 04/52241

(51) Int. Cl. G09G 3/28

(52) U.S. Cl. 345/60

(57) ABSTRACT

The present invention relates to a device intended to generate a sustain signal on columns of cells in a display panel comprising a matrix of display cells that are organized in rows and columns, at least one column driver comprising at least two switches for applying selectively an input voltage to at least one column of cells. According to the invention, the device includes inductive means for generating said input voltage. These inductive means are intended to oscillate with the capacitor of the columns of cells selected by the column driver. In this device, the switches of the column driver are controlled so as to generate, by cooperation with the inductive means, the sustain signal to be applied to the columns of cells. This device is particularly advantageous as it uses the column driver switches of the display panel to generate the sustain signal pulses.

### FIELD OF THE INVENTION

The present invention relates to a method of generating a voltage signal on a plurality of columns of an AC plasma display panel during the sustain phase of the cells of the panel and to a plasma panel comprising this device.

### BACKGROUND OF THE INVENTION

Various types of AC plasma display panel (hereafter called PDP) exist, namely those that use only two crossed electrodes in order to define a cell, as described in Patent FR 2 417 848, and those of the “coplanar sustain” type, known in particular from European Patent EP A-0 135 382, in which each cell is defined at the intersection of a pair of electrodes, called “sustain” electrodes, and one or more other electrodes, called “column” electrodes, used more particularly for addressing the cells. The present invention is more particularly intended to be used in an AC PDP of the coplanar-sustain type.

The operation and the structure of an AC coplanar-sustain PDP will be explained below with reference to FIG. 1. The panel 1 comprises column electrodes X1 to X4 orthogonal to pairs P1 to P4 of sustain electrodes. Each intersection of a column electrode X1 to X4 with a pair of sustain electrodes P1 to P4 defines a cell C1 to C16 corresponding to an image pixel. In the non-limiting example of the description, only four column electrodes X1 to X4 and only four pairs of sustain electrodes P1 to P4 are shown, these forming four rows L1 to L4 of cells. However, the panel may of course have many more rows of cells.

The column electrodes X1 to X4 are generally used only for addressing. They are each connected in a conventional manner to a column driver 2.

The pairs of electrodes P1 to P4 each comprise what is called an “address-sustain” electrode Y1 to Y4 and what is called a sustain-only electrode E1 to E4. The address-sustain electrodes Y1 to Y4 fulfil an addressing function in cooperation with the column electrodes X1 to X4 and they fulfil a sustain function with the sustain-only electrodes E1 to E4. The sustain-only electrodes E1 to E4 are connected together and to a pulse generator 3, from which they all simultaneously receive cyclic voltage pulses for the purpose of performing sustain cycles.

The address-sustain electrodes Y1 to Y4 are individual electrodes and are connected to a row driver 4, from which they receive, in particular during a sustain phase, cyclic voltage pulses in synchronism with those applied to the sustain-only electrodes E1 to E4, but time-delayed relative to them, and, during an address phase, base pulses in synchronism with signals applied to the column electrodes X1 to X4.

The synchronization between the various signals applied to the various electrodes is provided by a synchronizing device 5 connected to the drivers 2 and 4 and to the generator 3.

The voltage pulses applied to the pairs of sustain electrodes P1 to P4 during a sustain phase are shown in FIG. 2. Each rising edge of the signal applied to the address-sustain electrodes Y1 to Y4 corresponds to a falling edge of the signal applied to the sustain-only electrodes E1 to E4. A sustain discharge occurs in the cells C1 to C16 arising from these edges. The signal applied to the column electrodes X1 to X4 during this phase is maintained at a low potential.

As may be seen in this figure, the sustain discharges in the cells of the PDP are produced by inversion of the coplanar voltage, that is to say by inversion of the voltage between the sustain-address electrodes Y1 to Y4 and the sustain-only electrodes E1 to E4.

It is also known, from International Patent Application WO 02/099779, to apply, to the column electrodes X1 to X4, during the sustain phase of the cells, pulses that are synchronous with the sustain signal applied to the sustain electrodes P1 to P4 in order to promote the initiation of the discharge in the cells and thus increase the luminous efficiency of the latter, and to control the instant of discharge more precisely, after inversion of the coplanar voltage. This method is illustrated by FIG. 3.

The pulse signal applied to the column electrodes X1 to X4 in order to promote the discharge between the coplanar electrodes is shown in this figure. At each rising and falling edge of the signals applied to the coplanar electrodes, or a little afterwards, a pulse of high amplitude, of the order of a hundred volts or so, and of short duration, a few hundred nanoseconds, is applied to the column electrodes of the PDP.

To implement this method, it is necessary for the PDP drivers to be equipped with one or more pulse generators capable of generating such pulses on a highly capacitive load corresponding to the load of the column electrodes X1 to X4 of the panel. Application WO 02/099779 proposes no means for generating these pulses.

### SUMMARY OF THE INVENTION

The present invention proposes a method and a device for generating a periodic signal comprising high-amplitude short-duration pulses on the columns of cells of the panel.

The present invention relates to a device for generating a sustain signal on columns of cells in a display panel comprising a matrix of display cells that are organized in rows and columns, at least one column driver comprising at least first and second switches for applying, respectively and selectively, an input voltage to at least one column of cells, and a control circuit for controlling the column driver switches, which device includes inductive means for generating said input voltage, said inductive means being intended to oscillate with the capacitor of the column or columns of cells selected by said column driver, wherein said first and second switches of the column driver are controlled so as to generate, by cooperation with the inductive means, said sustain signal to be applied to the column or columns of cells selected by said column driver.

This device is particularly advantageous as it uses the column drivers of the display panel to generate the sustain signal pulses.

In one particular embodiment, if the column driver includes, for each column of cells, a first switch and a second switch and if the first switch is connected between an input terminal that receives said input signal and a mid-point connected to said column of cells of the panel, and the second switch is connected between said mid-point and earth, then the inductive means comprise:
a solenoid, a first end of which is connected to said input terminal of said column driver;
a first DC voltage generator delivering a first DC voltage, the positive terminal of which is connected to a second end of said solenoid and the negative terminal of which is connected to earth; and
a second DC voltage generator, delivering a second DC voltage, the positive terminal of which is connected to said first end of the solenoid via a diode and the negative terminal of which is connected to the second end of the solenoid, the cathode of said diode being connected to the positive terminal of said second voltage generator, the sum of said first and second DC voltages being equal to the amplitude of the sustain signal pulses.

The operation of this device comprises five phases in order to generate the sustain pulses to be applied to the columns of cells of the panel.

The invention also relates to a display panel comprising a matrix of display cells that are organized in rows and columns, at least one column driver comprising at least first and second switches in order to apply, respectively and selectively, an input voltage or a zero voltage to at least one column of cells, a control circuit for controlling the column driver switches, and to the aforementioned device, the inductive means of which are connected to said column driver.

Preferably, the column drivers are distributed in groups. The column driver switches within any one group are controlled identically in order to apply the same sustain signal to the corresponding columns of cells and the drivers of the various groups are controlled with a time delay between them in order to stagger the discharge currents over the entire elementary period of the sustain phases.

### BRIEF DESCRIPTION OF THE DRAWINGS

The invention will be better understood, and other features and advantages will become apparent, on reading the description that follows, the description making reference to the appended drawings in which:

FIG. 1, already described, shows schematically a PDP to which the invention can apply;

FIG. 2, already described, shows the signals conventionally applied to the pairs of sustain electrodes of the PDP during a sustain phase;

FIG. 3, already described, shows the signals applied to the pairs of sustain electrodes of the PDP during a sustain phase according to Application WO 02/099779;

FIG. 4 shows a device according to the invention, capable of generating a sustain signal as shown in FIG. 3 on the column electrodes of the PDP;

FIG. 5 shows the voltage signal generated by the device of FIG. 4 and the signal of a current flowing through a solenoid of the device of FIG. 4; and

FIGS. 6A to 6E illustrate the operating phases of the device of FIG. 4.

### DETAILED DESCRIPTION OF PREFERRED EMBODIMENTS

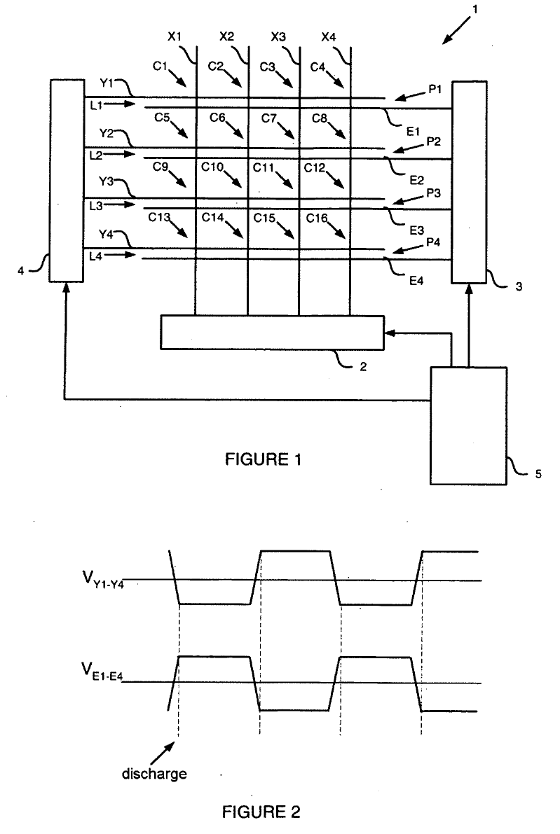

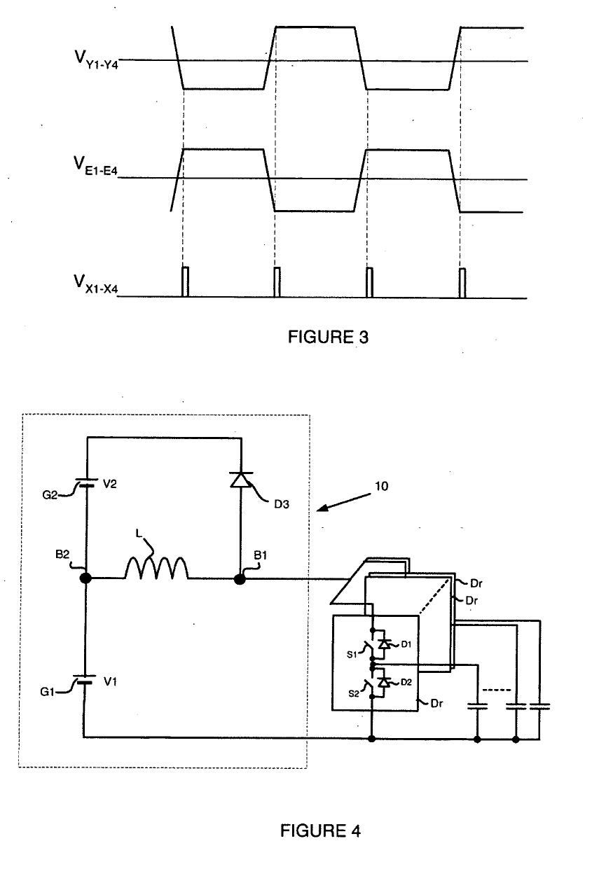

The invention proposes a device for generating short pulses on the column electrodes X1 to X4 or on the pairs of sustain electrodes of the PDP. This device may or may not be integrated into the driver 2 of FIG. 1.

One embodiment of the invention is shown in FIG. 4. In this figure, the device according to the invention uses the column drivers of the PDP, conventionally used to select columns of cells or groups of columns of cells of the PDP, in order to generate pulses on the column electrodes of the PDP. The columns of the PDP are shown in the figures by their capacitors.

Each column driver, referenced Dr, comprises, for the column of cells that it drives, two switches S1 and S2 mounted in series between an input terminal and earth, the mid-point between the two switches being connected to said column of cells, which switches are controlled by a control circuit (not shown in the figure). Each switch is provided with an anti-parallel diode between its terminals. These diodes are referenced D1 and D2 respectively for the elements S1 and S2 and generally correspond to the anti-parallel diodes of the MOS transistors used as switches.

The solenoid L is connected, from a first end B1, to the columns of cells of the PDP via the column drivers Dr. The end B1 is connected to the input terminal of the column drivers Dr. The second end B2 of the solenoid is connected to the positive terminal of a voltage source G1 capable of delivering a DC voltage V1. The negative terminal of the source G1 is connected to earth.

A second voltage source G2, capable of delivering a DC voltage V2, is connected to the terminals of the solenoid L via a second, overvoltage-limiting diode D3. The negative terminal of the source G2 is connected to the end B2 of the solenoid L and the cathode of the diode D2 is connected to the positive terminal of the source G2.

The voltages V1 and V2 and the control signals for the switches S1 and S2 will be defined in an example given later.

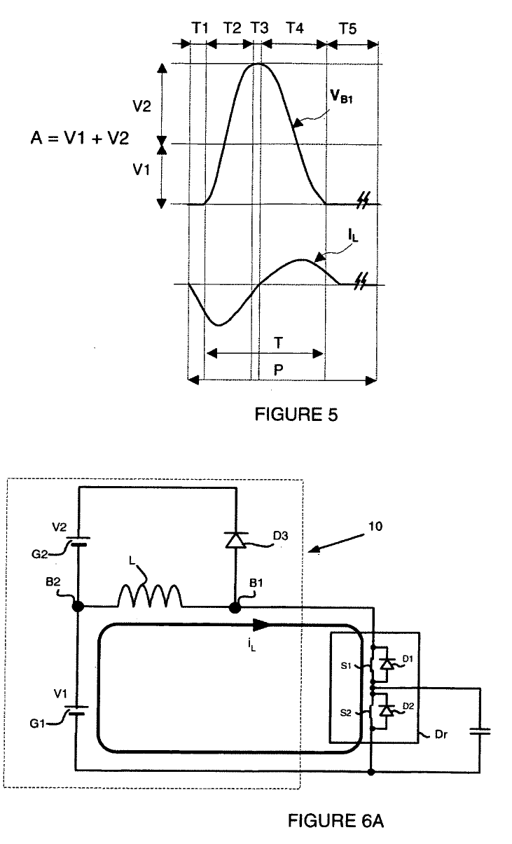

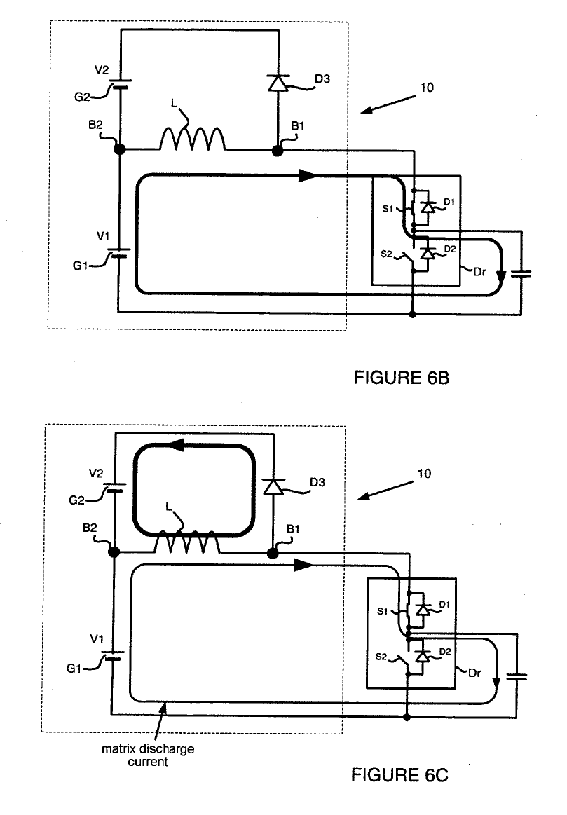

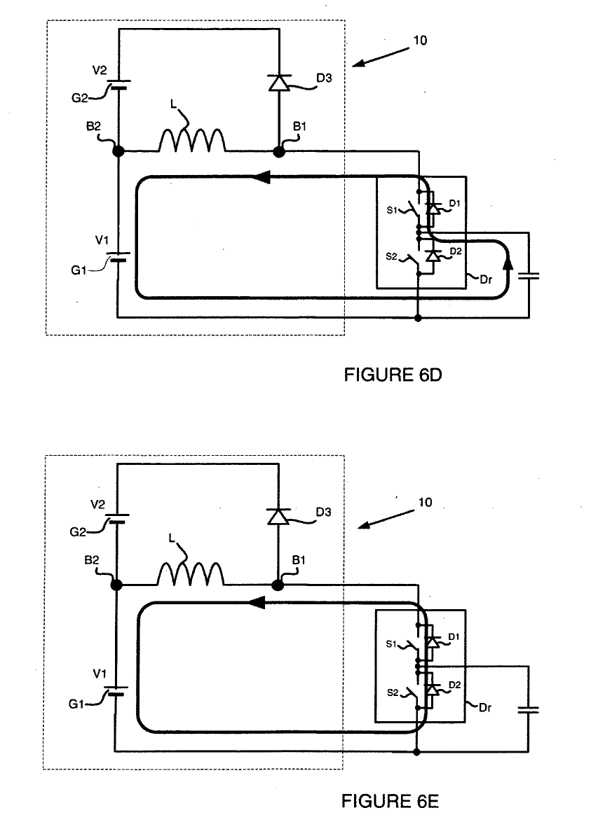

The operation of this device is illustrated in FIGS. 5 and 6A to 6E. FIG. 5 shows the waveform of the voltage V_{B1} applied to the columns of cells and also the waveform of the current i_{L} flowing through the solenoid L of the generator. The pulses of the voltage signal delivered to the columns of cells of the PDP have an amplitude A, a duration T and a period P. To simplify the explanation, only a single column driver Dr has been shown in FIGS. 6A to 6E. For the same reason, this column driver is connected only to a single column of cells and therefore has only two switches S1 and S2.

In the rest of the description, the expression “columns of cells selected by a driver” is understood to mean those columns of cells whose associated switch S1 is closed.

The voltage signal delivered to the column electrodes of the PDP is obtained through five operating phases:
a first phase, of duration T1, illustrated by FIG. 6A, during which the solenoid L stores current in the form of magnetic energy;
a second phase, of duration T2, illustrated by FIG. 6B, during which a portion of the current stored in the solenoid L is discharged into the columns of the PDP that are selected by the drivers Dr until the voltage across the terminals of said columns of the panel reaches the amplitude A;
a third phase, of duration T3, illustrated by FIG. 6C, during which the voltage of amplitude A is maintained across the terminals of the columns so as to create a matrix discharge current between the columns and the rows of the PDP cells in the written state and to make the current stored in the solenoid zero;
a fourth phase, of duration T4, illustrated by FIG. 6D, during which the solenoid L is charged with the current stored. in the capacitors of the selected columns until the voltage across the terminals of the latter becomes zero; and
a fifth phase, of duration T5, illustrated by FIG. 6E, during which the current through the solenoid L is zero.

As shown in FIG. 6A, the switches S1 and S2 of the driver Dr are placed in a closed state during the phase of duration T1. A current I_{L} flows through the circuit formed by the voltage source G1, by the solenoid L and by the switches S1 and S2. The intensity of the current I_{L} increases with that stored in the solenoid L. Depending on the convention adopted for illustrating this method, the current I_{L} is negative during this period. Since the input terminal of the column driver Dr is short-circuited to earth by the switches S1 and S2, the voltage across the terminals of the corresponding column of cells is zero.

FIG. 6B shows that the switch S2 is open during the period of duration T2. The switch S1 is maintained in the closed state. Some of the energy stored in the solenoid L is then discharged into the selected columns until the voltage across their terminals reaches the desired value A.

Referring to FIG. 6C this voltage across the terminals of the selected columns of cells is maintained over the duration T3 until the current I_{L} through the solenoid becomes zero. During this phase, the switches S1 and S2 are maintained in their respective states. The current remaining in the solenoid L is, partly, transferred into the selected columns of cells if they include cells in the written state and, partly, absorbed by the voltage source G2 via the diode D3. The current transferred to the columns of cells depends on the number of cells of the PDP in the written state that they contain. The larger this number, the lower the current absorbed by the voltage source G2. The current transmitted to the cells in the written state is an ignition current corresponding to a matrix discharge current between the row and the column of the cell. This matrix discharge current helps to improve the sustain discharge within the cell. The value of the current remaining in the solenoid L at the start of this phase is advantageously chosen to be equal to the value of the necessary matrix discharge current when all of the cells of the columns selected are simultaneously in the written state.

FIG. 6D shows that, when the solenoid has been completely discharged, the capacitive energy stored in the capacitor of the selected columns is returned to the solenoid L. The current I_{L} then changes direction. The amplitude of the current I_{L} reached at the end of this phase of duration T4 is lower than that reached at the end of the phase of duration T1, since energy was absorbed by the voltage source G2 during the phase of duration T3. The voltage across the terminals of the selected columns drops until it becomes zero. During this period, the switches are maintained in the same state as during the preceding phase.

Finally, FIG. 6E shows that the energy stored in the solenoid L is discharged into the voltage source G1 until the current I_{L} becomes zero. During this period, it does not matter whether the switches Si and S2 are in an open or a closed state since, if they are in the open state, the current I_{L} flows via the diodes D1 and D2.

The voltages V1 and V2, the durations T1, T2, T3, T4 and T5 and the inductance L of the solenoid are set by the following rules:

To reduce the operating losses to a minimum, V1 will be chosen to be slightly less than V2 so that the current in the solenoid is zero at the end of T4.

The oscillation period 2π\sqrt{LC} of the circuit is approximately equal to T2+T3+T4, where C is the capacitance of the set of columns driven by the column drivers Dr, and V1+V2=A.

Moreover, the period P, equal to T1+T2+T3+T4+T5, is equal to the half-period P′/2 of the sustain signal applied to the pairs of sustain electrodes of the PDP. If the frequency of the sustain signal applied to the pairs of sustain electrodes is equal to 200 kHz, then P=T1+T2+T3+T4+T5=2.5 μs. Thus, taking T=T2+T3+T4 (the duration of the pulse)=200 ns and C=6 nF (the capacitance of the columns driven by the drivers Dr, corresponding for example to 1/27 of the columns of the PDP), then L≈170 nH.

Advantageously, the column drivers Dr of the panel are distributed in N groups. The drivers within any one group are driven identically and simultaneously and the drivers for different groups are driven with a time delay between them. This division into N groups makes it possible to stagger the N associated matrix pulses over time and thus to spread out the matrix discharge currents. The peak current of these discharges in the device is thus reduced by a factor of N. It will then be sufficient, in order for these pulses to continue to promote the initiation of the discharges between coplanar electrodes, to extend the duration of the coplanar pulses so that these column pulses take place sufficiently early before the end of the coplanar pulses.

1. Device for generating a sustain signal on columns of cells in a display panel comprising a matrix of display cells that are organized in rows and columns, at least one column driver comprising at least first and second switches for applying, respectively and selectively, an input voltage or a zero voltage to at least one column of cells, and a control circuit for controlling the column driver switches, which device includes inductive means for generating said input voltage, said inductive means being intended to oscillate with the capacitor of the column or columns of cells selected by said column driver, wherein said first and second switches of the column driver are controlled so as to generate, by cooperation with the inductive means, said sustain signal to be applied to the column or columns of cells selected by said column driver.

2. Device according to claim 1, wherein a first switch and a second switch are provided for each column of cells, said first switch being connected between an input terminal that receives said input signal and a mid-point connected to said column of cells of the panel, and said second switch being connected between said mid-point and earth, wherein said inductive means comprise:
a solenoid, a first end of which is connected to said input terminal of said column driver;
a first DC voltage generator delivering a first DC voltage, the positive terminal of which is connected to a second end of said solenoid and the negative terminal of which is connected to earth; and
a second DC voltage. generator, delivering a second DC voltage, the positive terminal of which is connected to said first end of the solenoid via a diode and the negative terminal of which is connected to the second end of the solenoid, the cathode of said diode being connected to the positive terminal of said second voltage generator, the sum of said first and second DC voltages being equal to the amplitude of the sustain signal pulses.

3. Display panel comprising a matrix of display cells that are organized in rows and columns, at least one column driver comprising at least first and second switches in order to apply, respectively and selectively, an input voltage or a zero voltage to at least one column of cells, and a control circuit for controlling the column driver switches, wherein it includes a device according to claim 1 or 2, the inductive means of which are connected to said column driver.

4. Display panel according to claim 3, wherein the column drivers are distributed in groups and in that the column driver switches within any one group are controlled identically in order to apply the same sustain signal to the corresponding columns of cells.

5. Display panel according to claim 4, wherein the driver switches for the columns of the various groups are controlled with a time delay between them.
